(19) United States
(12) Patent Application Publication
(10) Pub. No.: US 2019/0232995 A1
(43) Pub. Date: Aug. 1, 2019

(54) METHOD FOR UNLOCKING AND/OR OPERATING A LOCKING DEVICE OF A SUPERIMPOSED STEERING SYSTEM OF A MOTOR VEHICLE AND LOCKING DEVICE

(71) Applicant: TB Deu Abwicklungs-Aktiengesellschaft, Aschaffenburg (DE)

(72) Inventors: André RÜDIGER, Berlin (DE); Anno VON MARTIAL, Berlin (DE); Marco SENTLER, Berlin (DE)

(73) Assignee: TB Deu Abwicklungs-Aktiengesellschaft, Aschaffenburg (DE)

(21) Appl. No.: 16/258,360

(22) Filed: Jan. 25, 2019

(30) Foreign Application Priority Data
Jan. 29, 2018 (DE) 10 2018 101 910.6

(51) Int. Cl. B62D 1/184

(52) U.S. Cl. CPC B62D 1/184; B62D 5/0475

(57) ABSTRACT

It is provided a method for unlocking a locking device of a superimposed steering system of a motor vehicle, wherein the locking device has a locking element which is located in a locking position in which it engages with a recess in a locking component of the locking device delimited by at least one abutment and thereby locks the superimposed steering system. The method comprises a movement of the locking component relative to the locking element into an unlocking preparatory position in which the locking element still engages with the recess, but is positioned spaced apart from the abutment, and a subsequent movement of the locking element from the recess into an unlocking position.

### CROSS REFERENCE TO RELATED APPLICATION

This application claims priority to German Patent Application No. 10 2018 101 910.6 filed on Jan. 29, 2018, the entirety of which is incorporated by reference herein.

### BACKGROUND

The disclosure relates to a method for unlocking a locking device of a superimposed steering system of a motor vehicle, to a method for operating a locking device of a superimposed steering system and to locking devices.

A superimposed steering system as part of a motor vehicle's active steering system produces a steering angle which is superimposed on a steering angle entered by a driver through actuation of the steering-wheel rim of the steering wheel. Accordingly, a rotational movement of a steering shaft connected to the steering wheel is made up of the steering angle entered by the driver and the steering angle produced by the superimposed steering system (in particular by a superimposed drive of the superimposed steering system). A superimposed steering system of this kind is known from WO 2007/009420 A1, for example.

Furthermore, a locking device for locking a superimposed steering system is known from WO 2012/120079 A1. Locking devices of this kind are used, in particular, to lock the superimposed steering system, e.g. for safety reasons in the event that the vehicle's electrical system should fail. When the superimposed locking system is in the locked state, direct mechanical access to the steering column, and therefore to the vehicle wheels, is guaranteed.

When the vehicle is started, the superimposed steering system is unlocked. The locking device comprises, in particular, a locking bolt which engages in the locked state with a component (e.g. in the form of a locking plate) of a superimposed transmission of the superimposed steering system. In order to unlock the superimposed steering system, the locking bolt is moved into an unlocking position in which it is no longer engaged with the component of the superimposed transmission. The movement of the locking bolt into the unlocking position may be accompanied by noises which arise, in particular, due to mechanical contact between the locking bolt and an abutment restricting movement and which are intensified by contact between the locking bolt and the component of the superimposed transmission when movement begins.

### SUMMARY

An object addressed by the proposed solution is that of preventing noise generation during the unlocking of a superimposed steering system in the most efficient way possible.

This object is solved by the provision of the method with features as described herein and also by the provision of the locking device having features as described herein.

According to a first aspect, a method is provided for unlocking a locking device of a superimposed steering system (in particular an active steering system) of a motor vehicle, wherein the locking device has a locking element which is located in a locking position in which it engages with a recess in a locking component of the locking device delimited by at least one abutment and thereby locks the superimposed steering system, wherein the method comprises the following steps:
movement of the locking component relative to the locking element into an unlocking preparatory position in which the locking element still engages with the recess, but is positioned spaced apart from the abutment; and
subsequent movement of the locking element from the recess into an unlocking position.

This prepositioning of the locking component relative to the locking element means that noise generation that could be caused when unlocking the superimposed steering system through contact between the locking element and the abutment during the outward movement from the recess into the unlocking position, is avoided. The recess is, in particular, a depression or a through-opening in the locking component. It is conceivable for the locking component to have two abutments which delimit the recess on mutually opposite sides. Moreover, the locking component may, of course, also exhibit more than one recess of this kind.

The locking component may be a locking plate, for example, which is moved into the unlocking preparatory position by rotation. It is conceivable for the locking plate to be moved into the unlocking preparatory position by being rotated until it adopts an angle position that lies within a specified angle position range defining the unlocking preparatory position.

According to another embodiment, the locking plate is connected to a drive shaft of a superimposed transmission of the superimposed steering system, wherein the rotation of the locking plate into the unlocking preparatory position takes place by rotating the drive shaft with the help of a motor (in particular an electric motor). The drive shaft is, for example, a worm screw which meshes with a worm gear. The basic design of the superimposed transmission and the locking device (stopping device) is described in WO2010/115707 A1 or WO 2012/120079 A1, to which reference is hereby expressly made.

The rotation of the locking plate into the unlocking preparatory position takes place iteratively, in particular in the form of multiple rotational steps spaced apart from one another in time.

For example, the motor is activated for a first period of time, wherein the angle position of the locking plate is then determined and checked to see whether it lies within the angle position range, wherein the motor is activated for a second period of time if the angle position determined lies outside the angle position range.

During the first and second period of time, for example, the activated motor exerts a first or second torque (in particular in the form of a torque surge in each case) on the drive shaft, wherein the second torque (the magnitude of the second torque) depends on the angle position determined after the first period of time. For example, a second torque is applied, the magnitude of which is greater than the magnitude of the first torque when, after the first period of time, the difference between the angle position of the locking plate and the angle position range is greater than a predetermined maximum difference. It is also conceivable for the magnitude of the second torque to be smaller than the magnitude of the first torque if the difference between the angle position of the locking plate after the first period of time and the angle position range is smaller than a predetermined minimum difference.

According to a second aspect, the embodiment relates to a method for operating a locking device of a superimposed steering system of a motor vehicle, in particular for use in a method according to the first aspect, wherein the locking device has a locking element which engages in a locking position with a recess in a locking component of the locking device delimited by at least one abutment, comprising the steps:
movement of the locking element into the locking position;
movement of the locking component relative to the locking element with the help of a component of a superimposed transmission of the superimposed steering system until the abutment comes into contact with the locking element and a tensioning state is produced in the superimposed transmission;
application of an increasing force and/or an increasing torque to the locking component in order to remove the abutment from the locking element and relax the tensioning state; and
determination of a force and/or a torque with which the tensioning state is relaxed.

By producing a tensioning state and determining a force and/or a torque which is required to relax the tensioning state, a movement resistance within the superimposed transmission created, in particular, due to friction between components of the superimposed transmission (for example between a worm screw and a worm wheel) can be determined. In this way, a minimum torque can be determined, for example, which must be exerted in order to start a component (for example the aforementioned worm screw) of the superimposed transmission rotating.

The force and/or torque at which the tensioning state is relaxed is determined, for example, by establishing a force and/or a torque at which the abutment is removed from the locking element.

As already mentioned above in relation to the first aspect, the component of the superimposed transmission is, for example, a drive shaft (in particular in the form of a worm screw) that is movable with the help of a motor and the locking component is a locking plate connected to the drive shaft. With the help of the method as described herein the minimum torque required in order to start the locking plate rotating can, in particular, be determined.

According to another embodiment, at least during application of the increasing force and/or the increasing torque on the locking component, a variable dependent on the speed of the locking component and/or the component of the superimposed transmission or the speed (of the locking component and/or the component of the superimposed transmission) itself is determined, wherein the force exerted at a point in time at which this variable or the speed reaches a predetermined minimum value or the torque exerted at this point in time is determined as the force or the torque at which the tensioning state is relaxed. For example, the determined variable is a speed or an angular velocity of the aforementioned motor via which the drive shaft is driven.

Another variant envisages that after the force and/or torque has been determined, the method described above according to the first aspect is carried out, wherein the movement of the locking component into the unlocking preparatory position takes place at least initially by exerting a force or torque on the locking component which at least corresponds to the force or torque which was determined using the method according to the second aspect.

The force determined according to the second aspect or the torque determined in this manner is therefore used to move the locking component into the unlocking preparatory position, as a result of which, for example, the most instantaneous movement possible of the locking component and therefore the quickest possible unlocking of the locking device can take place. It is conceivable for the force determined with the help of the method according to the second aspect or the torque determined as the starting value for the iterative movement of the locking component into the unlocking preparatory position, as described above, to be used.

Furthermore, it is conceivable for the force determined according to the second aspect and/or the torque determined for controlling processes of the superimposed steering system to be used which are not related to the unlocking of the locking device.

It is pointed out that the embodiments of the method described above can naturally also be used similarly according to the first aspect for development of the method according to the second aspect. Furthermore, the control of the locking component and/or of the locking element required in order to implement the method as described herein can take place with the help of a correspondingly programmed unit of the vehicle (in particular the vehicle's ECU).

The disclosure further relates to a locking device for a superimposed steering system of a motor vehicle, in particular for implementing the method according to the first aspect, having
a locking element which in order to lock the superimposed steering system is moved from an unlocking position into a locking position and in order to unlock the superimposed steering system from the locking position into the unlocking position, in which it engages with a recess in a locking component of the locking device delimited by at least one abutment, wherein
the locking device is configured in order to unlock the superimposed steering system to move the locking component relative to the locking element into an unlocking preparatory position initially in which the locking element still engages with the recess but is positioned spaced apart from the abutment and then to move the locking element out of the recess into the unlocking position.

Moreover, the disclosure relates to a locking device for a superimposed steering system of a motor vehicle, in particular for implementing the method according to the second aspect, having
a locking element which in order to lock the superimposed steering system can be moved out of an unlocking position into a locking position and in order to unlock the superimposed steering system can be moved out of the locking position into the unlocking position in which it engages with a recess of a locking component of the locking device delimited by at least one abutment, wherein
the locking device is designed
   to move the locking component relative to the locking element with the help of a component of a superimposed transmission of the superimposed steering system until the abutment comes into contact with the locking element and a tensioning state is produced in the superimposed transmission;
   to exert an increasing force and/or an increasing torque on the locking component to remove the abutment from the locking element and to relax the tensioning state; and
   to determine a force and/or a torque at which the tensioning state is relaxed.

The components of the locking devices as described herein, in particular the locking element, the locking component and/or the components of the superimposed transmission, may of course be configured according to the exemplary embodiments explained above in connection with the method in accordance with the first and second aspects.

The disclosure also relates to a superimposed steering system with a locking device as described herein and also a motor vehicle with a superimposed steering system of this kind.

### BRIEF DESCRIPTION OF THE DRAWINGS

The embodiments are explained in greater detail below with the help of exemplary embodiments with reference to the figures.

FIG. 1 shows a superimposed transmission of a superimposed steering system.

FIG. 2 shows a representation of the time profile of an angular velocity of the motor of the superimposed transmission and a torque applied by the motor on the worm screw of the superimposed transmission during implementation of the method according to the second aspect.

FIGS. 3 to 6 show different states of the locking device during implementation of the method according to the second aspect.

FIG. 7 shows a representation of the time profile of the torque applied by the motor of the superimposed transmission on the worm screw during implementation of the method according to the first aspect.

FIG. 8 shows a representation of the time profile of the motor angle during implementation of the method according to the first aspect.

FIGS. 9 to 12 show different states of the locking device during implementation of the method according to the first aspect.

### DETAILED DESCRIPTION

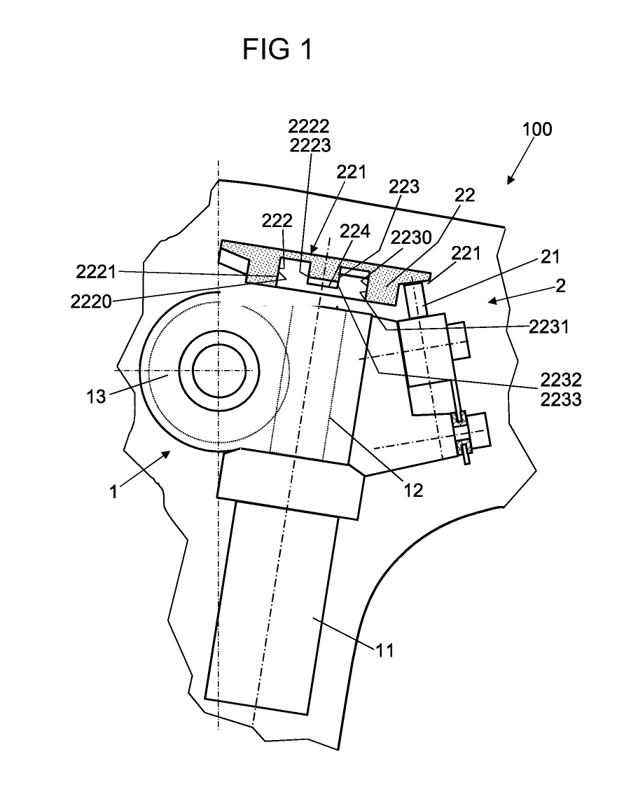

FIG. 1 shows a superimposed drive 1 known per se of a superimposed steering system arranged on a steering wheel 100 of a motor vehicle. The superimposed drive 1 comprises, for example, a drive shaft driven by a motor 11 in the form of a worm screw 12 which meshes with a worm wheel 13. The worm wheel 13 is in turn connected to a steering shaft of the vehicle.

The superimposed drive 1 furthermore has a locking device 2 for locking the superimposed steering system. The locking device 2 comprises a locking element in the form of a locking bolt 21 which, which the help of a spring, can be moved from a starting position into the locking position shown in FIG. 1 and back again into the starting position with the help of a lifting magnet. For example, the locking bolt 21 forms an armature of the lifting magnet or is connected to an armature of the lifting magnet. In the locking position, a free end of the locking bolt 21 engages with a recess 221 in a locking component in the form of a locking plate 22 connected to, and co-rotating with, the worm screw 12. Through the engagement of the locking bolt 21 with the recess 221, the locking plate 22 and therefore the worm screw 12 are locked.

The locking plate 22 comprises a plurality of recesses 221 which each have a first and second depression in the form of a first and second pocket 222, 223 and also a transitional region 224 with a shallower depth located between the first and the second pockets 222, 223. The recesses 221 are each delimited by a side wall 2221 of the first pocket 222 and a side wall 2231 of the second pocket 223, wherein the pockets 222, 223 are delimited on their sides opposite the side walls 2221, 2231 by side walls 2222, 2232. The side walls 2221, 2231, 2222, 2232 each create an abutment 2220, 2230, 2223, 2233 for the locking bolt 21. In particular, in the locking position during rotation in the rotational direction of the worm screw 12 indicated in FIG. 4 and therefore of the locking plate 22, the locking bolt 21 will come into contact with the (left) abutment 2220 created by the side wall 2221 of the first pocket 222 and prevent further rotation of the locking plate 22.

It is pointed out that FIG. 1 only shows an example of a superimposed transmission with which the solution can be realized. However, the solution is of course not restricted to a particular embodiment of the superimposed transmission. Another embodiment of the locking plate, in particular of the recesses 221, is conceivable, for example. For instance, the recesses 221 may be at least partially configured as through-openings and/or only have a single pocket.

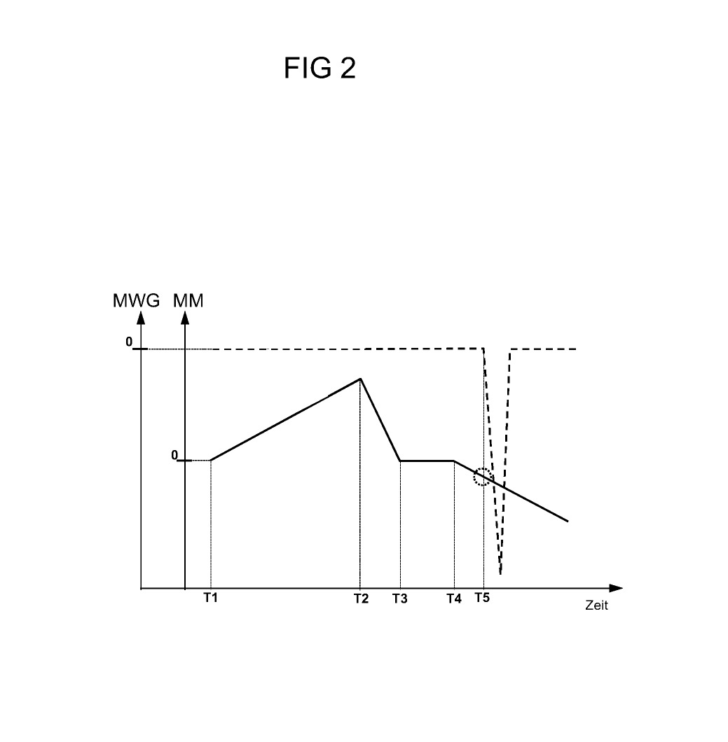

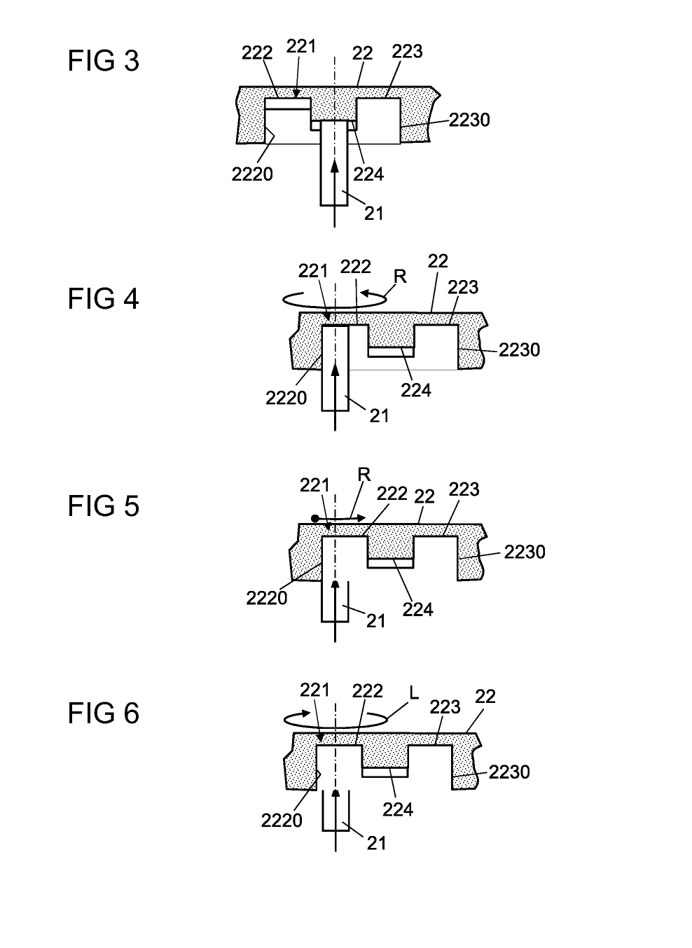

FIG. 2 shows in conjunction with FIGS. 3 to 6 the time dependence of the angular velocity of the motor (MWG, shown as a dotted line in FIG. 2) of the superimposed transmission and also the torque (motor torque MM) exerted by the motor on the worm screw during implementation of the inventive method according to the second aspect. This method is used, in particular, to determine the minimum torque that the motor of the superimposed transmission must exert in order to start the worm screw and therefore the locking plate 22 rotating.

In order to implement the method, the locking bolt 21 is initially moved into the recess 221 in the locking plate 22. For example, following movement into the recess 221, the locking bolt 21 is located the transitional region 224 thereof (FIG. 3). The locking plate 22 is rotated in an anti-clockwise direction (along the rotational direction R), so that the locking bolt 21 comes into contact with the abutment 2220 (FIG. 4) at time T1 in FIG. 2 and the motor angular velocity MWG is, accordingly, zero.

It is pointed out that the preceding and following explanations in relation to a particular rotational direction of the locking plate 22 also apply similarly to the opposite rotational direction.

The motor torque MM is then increased at time T2 in order to produce a tensioning state in the superimposed transmission (in particular between the worm screw and the worm wheel). In this case, a motor torque MM profile of this kind is used to produce a tensioning state which is maintained even with a subsequent lowering of the motor torque MM up to time T3 and a subsequent holding of the motor torque MM up to time T4. In particular, the locking bolt 21 also remains in contact with the abutment 2220 up to time T4. Accordingly, the motor angular velocity MWG also remains at least approximately at zero. The reduction in the motor torque at time T3 is indicated in FIG. 5 by the shortened arrow R.

Following the holding phase, i.e. after time T4, the motor is activated in such a manner that a torque opposing the original direction of rotation R is exerted on the worm screw. The tensioning state of the superimposed transmission and also the contact between the locking bolt 21 and the abutment 2220 are still maintained to begin with, however, even after this opposing torque has been exerted. Only when the exerted torque reaches a required minimum torque (at time T5) does the tensioning state relax and the locking plate 22 is moved relative to the locking bolt 21, so that the locking bolt 21 is removed from the abutment 2220 (FIG. 6).

At time T5 the motor angular velocity MWG also changes accordingly, wherein the magnitude of the motor angular velocity MWG passes through a minimum and at a time at which the right abutment 2230 comes into contact with the locking bolt 21 it returns to zero. By detecting the motor torque at time T5, the minimum torque necessary in the current state of the superimposed transmission in order to bring about an initial turning (i.e. start of rotation) of the locking plate 22 can be determined. It is also conceivable for the torque to be used to start the turning of the locking plate 22 not to be determined exactly at time T5, but at a time at which the magnitude of the motor angular velocity MWG or the speed of the motor reaches a predefinable threshold value.

It is conceivable for the method according to the embodiment described according to FIGS. 2 to 6 always to be carried out when the vehicle is not running, i.e. the engine is switched off.

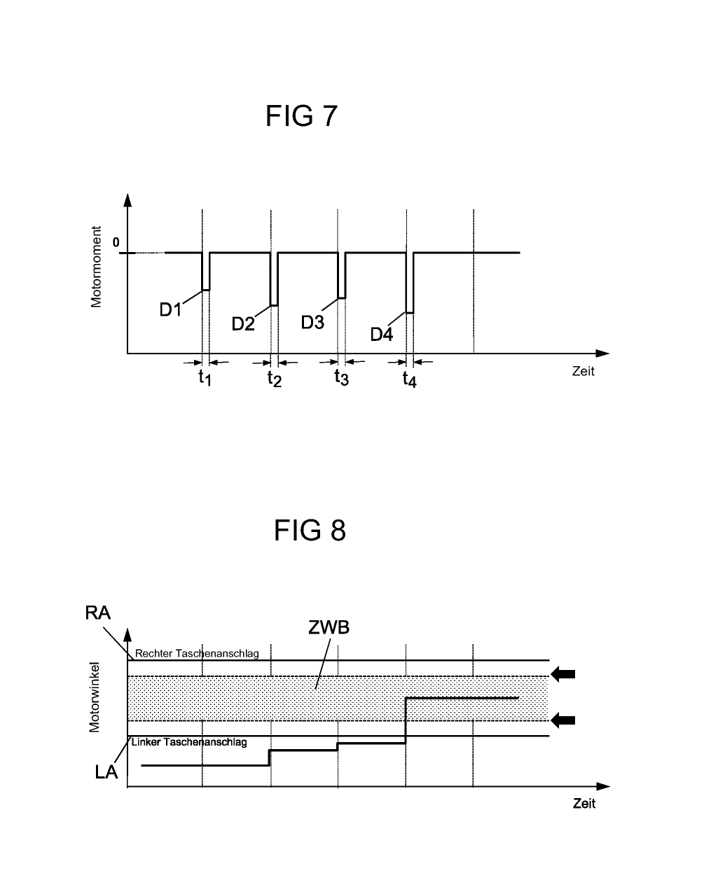

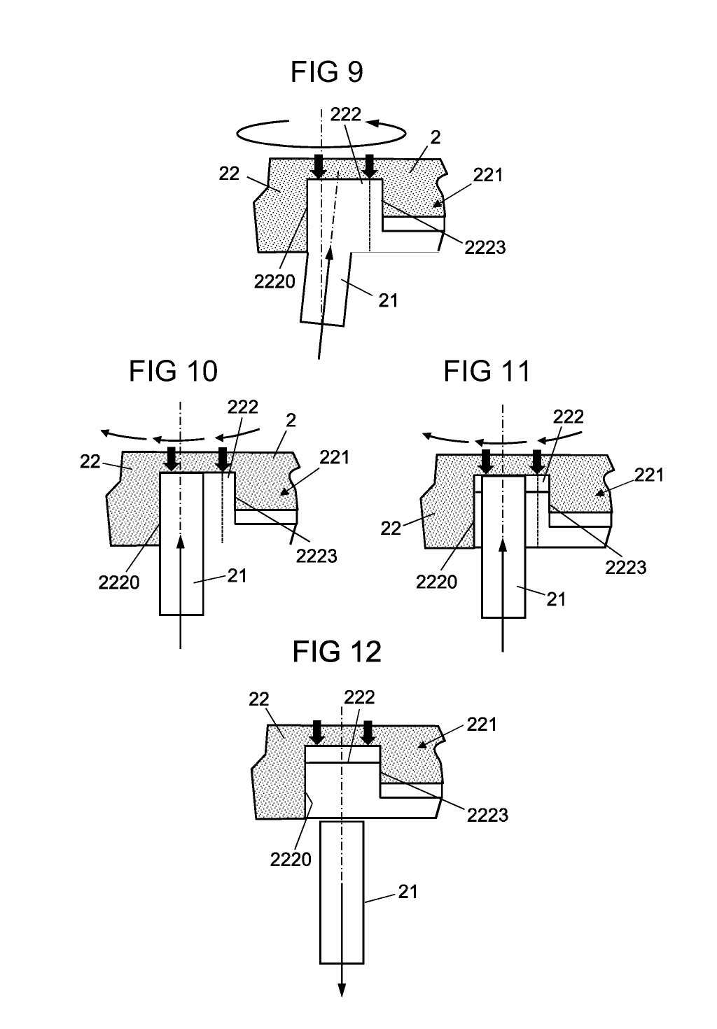

FIGS. 7 to 12 relate to the implementation of the method according to the first aspect which is used to move the locking bolt 21 from the locking position depicted in FIG. 9 into the unlocking position with the smallest possible force and noise generation.

FIG. 9 shows the state of the locking bolt 21 in the locking position, wherein it is in contact with the left abutment 2220 of the recess 221 or the pocket 222. The inclined position of the locking bolt 21 shown in FIG. 9 may occur due to the transverse force exerted on it via the abutment 2220, in particular if the bearing via which the locking bolt 21 is mounted on the actuator assigned to it (in particular in the form of the lifting magnet already mentioned) exhibits some play. Before the locking bolt 21 is unlocked, there is a pre-positioning of the locking plate 22 relative to the locking bolt 21. For this purpose, the locking plate 22 is gradually rotated until it is in an unlocking preparatory position in which the locking bolt 21 is positioned at a distance from the abutments 2220, 2223 of the pocket 222 (FIG. 12).

The gradual rotation of the locking plate 22 takes place through torque surges exerted at intervals and illustrated in FIG. 7. According to this, with the help of the motor of the superimposed transmission, a torque (motor torque) D1-D4 is applied intermittently over multiple periods of time t₁-t₄ to the worm screw and therefore to the locking plate 22. The torque surges, i.e. the periods of time t₁-t₄, are spaced apart from one another in time, wherein the gaps in time may be constant, as shown in FIG. 7. The minimum torque required in order to start turning the locking plate 22, i.e. the motor torque applied at time T5 in FIG. 2, which is determined with the help of the method as described herein is particularly used as the starting value, i.e. as torque D1.

The magnitude of the torque applied in each case depends on the motor angle, for example, in other words the angular position of the locking plate 22. In the present case, the motor angle is located outside the predetermined target angle position range ZWB depicted by the shaded area in FIG. 8, even after the first torque surge has been applied (with torque D1). In FIG. 8 the motor angle sensed is depicted relative to the position of the locking bolt 21, wherein two horizontal lines LA, RA characterize the left and right abutment 2220, 2223 of the pocket 222. It should be pointed out that according to FIG. 8 the locking bolt 21 would appear to be located on the other side of the left abutment (line LA). This effect is attributable to the inclined position of the locking bolt 21 explained earlier with the help of FIG. 9.

The magnitude of the respective torque during the torque surges is therefore increased or reduced depending on the angle position of the locking plate 22 achieved with the preceding torque surge, wherein torque surges are applied until the locking plate 22 is located in the predetermined angle position range ZWB and the locking bolt 21 is therefore in a target zone (characterized by vertical arrows in FIGS. 9 to 12) positioned between the left and right abutment 2220, 2223 and, accordingly, is not exposed to any transverse force. Having reached the predetermined angle position region ZWB (i.e. the unlocking preparatory position) the locking bolt 21 is moved from recess 221 into the unlocking position and therefore disengaged from the locking plate 22 (FIG. 12).

1. A method for unlocking a locking device of a superimposed steering system of a motor vehicle, wherein the locking device has a locking element which is located in a locking position in which it engages with a recess in a locking component of the locking device delimited by at least one abutment and thereby locks the superimposed steering system, comprising the steps:
movement of the locking component relative to the locking element into an unlocking preparatory position in which the locking element still engages with the recess, but is positioned spaced apart from the abutment; and
subsequent movement of the locking element from the recess into an unlocking position.

2. The method according to claim 1, wherein the locking component is a locking plate which is moved into the unlocking preparatory position by rotation.

3. The method according to claim 2, wherein the locking plate is rotated until it adopts an angle position that lies within a specified angle position range.

4. The method according to claim 2, wherein the locking plate is connected to a drive shaft of a superimposed transmission of the superimposed steering system, wherein the rotation of the locking plate into the unlocking preparatory position takes place by rotating the drive shaft with the help of a motor.

5. The method according to claim 3, wherein the angle position range corresponds to a motor angle range, wherein the motor rotates the drive shaft until the motor angle lies within the motor angle range.

6. The method according to claim 2, wherein the rotation of the locking plate into the unlocking preparatory position takes place iteratively.

7. The method according to claim 3, wherein the rotation of the locking plate into the unlocking preparatory position takes place iteratively and the motor is activated for a first period of time, wherein the angle position of the locking plate is then determined and checked to see whether it lies within the angle position range and the motor is activated for a second period of time if the angle position determined lies outside the angle position range.

8. The method according to claim 7, wherein the activated motor exerts a first or second torque on the drive shaft during the first and second period of time, wherein the second torque depends on the angle position of the locking plate determined after the first period of time.

9. A method for operating a locking device of a superimposed steering system of a motor vehicle, wherein the locking device has a locking element which engages in a locking position with a recess in a locking component of the locking device delimited by at least one abutment, comprising the steps:
movement of the locking element into the locking position;
movement of the locking component relative to the locking element with the help of a component of a superimposed transmission of the superimposed steering system until the abutment comes into contact with the locking element and a tensioning state is produced in the superimposed transmission;
application of an increasing force and/or an increasing torque to the locking component in order to remove the abutment from the locking element and relax the tensioning state; and
determination of a force and/or a torque with which the tensioning state is relaxed.

10. The method according to claim 9, wherein the force and/or the torque at which the tensioning state is relaxed is determined by establishing a force and/or a torque at which the abutment is removed from the locking element.

11. The method according to claim 9, wherein the component of the superimposed transmission is a drive shaft that is movable with the help of a motor and the locking component is a locking plate connected to the drive shaft.

12. The method according to claim 9, wherein at least during application of the increasing force and/or the increasing torque on the locking component, a variable dependent on the speed of the locking component and/or the component of the superimposed transmission or the speed itself is determined, wherein the force exerted at a point in time at which this variable or the speed reaches a predetermined minimum value or the torque exerted at this point in time is determined as the force or the torque at which the tensioning state is relaxed.

13. The method according to claim 11, wherein at least during application of the increasing force and/or the increasing torque on the locking component, a variable dependent on the speed of the locking component and/or the component of the superimposed transmission or the speed itself is determined, wherein the force exerted at a point in time at which this variable or the speed reaches a predetermined minimum value or the torque exerted at this point in time is determined as the force or the torque at which the tensioning state is relaxed, wherein the variable is a speed or an angular velocity of the motor.

14. The method according to claim 9, wherein after the force and/or torque has been determined, a method for unlocking a locking device of a superimposed steering system of a motor vehicle is carried out,
wherein the locking device has a locking element which is located in a locking position in which it engages with a recess in a locking component of the locking device delimited by at least one abutment and thereby locks the superimposed steering system, comprising the steps movement of the locking component relative to the locking element into an unlocking preparatory position in which the locking element still engages with the recess, but is positioned spaced apart from the abutment, and subsequent movement of the locking element from the recess into an unlocking position, and
wherein the movement of the locking component into the unlocking preparatory position takes place at least initially by exerting a force or torque on the locking component which at least corresponds to the force or torque which was determined using the method according to claim 9.

15. A locking device for a superimposed steering system of a motor vehicle, having a locking element which in order to lock the superimposed steering system is moved from an unlocking position into a locking position and in order to unlock the superimposed steering system from the locking position into the unlocking position, in which it engages with a recess in a locking component of the locking device delimited by at least one abutment, wherein the locking device is configured in order to unlock the superimposed steering system to move the locking component relative to the locking element into an unlocking preparatory position initially in which the locking element still engages with the recess but is positioned spaced apart from the abutment and then to move the locking element out of the recess into the unlocking position.

16. A locking device for a superimposed steering system of a motor vehicle, having a locking element which in order to lock the superimposed steering system can be moved from an unlocking position into a locking position and in order to unlock the superimposed steering system from the locking position into the unlocking position, in which it engages with a recess in a locking component of the locking device delimited by at least one abutment, wherein the locking device is designed
to move the locking component relative to the locking element with the help of a component of a superimposed transmission of the superimposed steering system until the abutment comes into contact with the locking element and a tensioning state is produced in the superimposed transmission;
to exert an increasing force and/or an increasing torque on the locking component to remove the abutment from the locking element and to relax the tensioning state; and
to determine a force and/or a torque at which the tensioning state is relaxed.
